(19) United States
(12) Patent Application Publication
(10) Pub. No.: US 2017/0285581 A1
(43) Pub. Date: Oct. 5, 2017

(54) REMOTE ALARM CLOCK

(71) Applicant: Benyomen MARKSTEIN, Brooklyn, NY (US)

(72) Inventor: Benyomen MARKSTEIN, Brooklyn, NY (US)

(21) Appl. No.: 15/084,036

(22) Filed: Mar. 29, 2016

(51) Int. Cl. G04G 13/02

(52) U.S. Cl. CPC G04G 13/021

(57) ABSTRACT

The alarm clock system provided with an alarm clock base unit and a remote alarm controller such that the current system does not afford a sleeping person additional rest after the initial activation of an alarm. The alarm can be deactivated only from a distance, thereby requiring the sleeper to get out of bed and use the remote to deactivate the alarm. The alarm clock system with a remote control does not allow indefinite postponement of wakefulness, thereby solving the purpose for which it is deployed. The large, highly visible display allows placement of the device at any convenient location, rather than only in close proximity to the sleeper. The alarm clock also displays the current date. The clock is capable of continued operation using power from rechargeable batteries.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

This invention relates to the field of clocks and other awakening devices. More particularly, the invention relates to an alarm clock with a remote alarm controller.

### 2. Description of Related Art Including Information Disclosed Under 37 CFR 1.97 and 37 CFR 1.98

The statements in this section merely provide background information related to the present disclosure, and may not constitute prior art.

For most people, the beginning of a work day is announced by an alarm clock. However, the transition from sleep to wakefulness is difficult for many people, and numerous practices and devices have been implemented with the intention of facilitating this transition. Some people use alarm clocks with unpleasant or extraordinarily loud audible signals to jar the sleeper awake. Others place their alarm clocks at a distance from their beds, so that physical activity is required to deactivate the alarm. Such abrupt methods of waking the sleeper are undesirable to many. For a more gentle transition to wakefulness, many “clock radios” are available, in which a radio and alarm clock are incorporated into a single unit. In most of these devices, the user may choose to be awakened by music from a radio broadcasting station of their choice, rather than by a traditional alarm signal. Unfortunately, this approach, while gentle, often results in oversleeping, as it is easy for many to continue to sleep in the presence of music. Indeed, music is often used to encourage sleep.

Alarm clocks have been used for a long time to awaken sleepers, particularly to help them begin their work days. Alarm clocks coupled with a snooze function have been known for years. While the snooze function may aid in alleviating the problem of waking the sleeper, sound sleepers may deactivate both the clock alarm and the snooze alarm, resulting in the sleeper's oversleeping. Although the alarm clock serves as a wake-up assistant for most people, such a device should ensure to awaken the sleepers at the set time without any oversleeping.

Alarm clocks almost universally include an external switch to disable an alarm. For example, the external switch can include a slider or a pushbutton prominently positioned on the alarm clock housing. However, because a person need only to depress a bedside switch to deactivate the alarm, many alarm clocks fail to adequately awaken the individual against the temptation to simply return to sleep.

A number of alarm clocks have been proposed in an attempt to overcome these shortcomings. For example, one proposed alarm clock includes a housing that has multiple push buttons that illuminate in a random sequence. The alarm is deactivated after the user depresses the push buttons in the order illuminated. Another proposed construction includes a manual pushbutton separate from the alarm clock housing. According to this construction, the alarm is deactivated in response to the depression of the pushbutton for an extended period of time, for example twelve seconds.

The prior art in this category revealed the following prior U.S. Pat. Nos.: Newman, U.S. Pat. No. 2,239,160, Belich, U.S. Pat. No. 2,496,373, Dias, U.S. Pat. No. 3,005,919, Atkins et al, U.S. Pat. No. 3,081,594, Kleinerman, U.S. Pat. No. 3,320,739, McLeod et al, U.S. Pat. No. 3,498,047, Welty, U.S. Pat. No. 3,855,574, Scheer et al, U.S. Pat. No. 4,084,104, Yamazaki et al, U.S. Pat. No. 4,121,414.

The alarm clocks, use a “snooze button,” by which an activated alarm signal is rendered temporarily inoperative, affording the sleeper additional rest after being initially awakened, and thereby allowing a sleeper opportunity to awaken gradually. In the current implementations of such a delay feature, the snooze button is located on the alarm clock, which is then placed in close proximity to the sleeper to allow the snooze feature to be activated without the sleeper getting out of bed. Unfortunately, convenient use of such a snooze feature requires placement of the clock within close proximity to the user, which can result in several problems First, such placement of the alarm clock unit allows for repeated use of the snooze feature, which can result in oversleeping. Close proximity of the alarm clock unit to the sleeper also allows for easy permanent deactivation of the alarm signal, which again can result in oversleeping. Although these problems are well known in the art, none of the existing alarm clocks that incorporate a delay or snooze feature address said problems with the same degree of success as the present invention.

Examples of prior art alarm clocks with some kind of remote controller include that disclosed in U.S. Pat. No. 4,316,273, to Jetter, which proposes a local alarm signal unit placed in close proximity to the sleeper with a remote unit containing the means for deactivating the alarm. The remote placement of the deactivating unit forces the sleeper to get out of bed and move to the location of the deactivating unit in order to stop the alarm signal. In this disclosure, the awakened person is also required to hold the deactivation switch for several seconds for the purpose of insuring the operator has thoroughly awakened, and thus preventing oversleeping. Once the deactivation requirements have been met, the disabling of the alarm signal is permanent. The Jetter disclosure further requires that the sleeper either get up immediately and satisfy the requirements for deactivating the alarm system, or otherwise endure the alarm signal. Thus, the method uses the separation of the alarm deactivating means from the alarm signal means in order to abruptly force wakefulness upon the user. Another prior art device in which an alarm clock system is separated into two elements is disclosed by Rothman in U.S. Pat. No. 4,218,875. In this invention, the alarm signal portion of the alarm clock is demountably attached to a clock, and is adapted to be removed from the clock and thrown against a surface without harm to the alarm signal unit. In this teaching, the alarm signal is deactivated following the impact of the alarm signal unit with a surface. Thus, a cathartic device is provided for a sleeper who is annoyed by the alarm signal, and also provides a novel means for deactivating the alarm. This invention does not, however, provide a means for gradually bringing the sleeper to wakefulness. Also, the invention proposed by this teaching does not help prevent termination of the alarm signal prematurely, that is, before the sleeper is fully awakened. Finally, this invention does not provide remote control over the alarm, as the throw-able portion of the alarm must be attached to the base unit during the inactive period of the alarm.

While the alarm clock systems in the prior art may satisfy some purposes for which they were designed, they would not be as suitable for the purposes of the present invention, as hereinafter described. One of the most important desirable characteristics of an alarm clock system is to ensure that the sleeper comes to full wakefulness by a desirable time, without making the transition from sleep to wakefulness overly abrupt or unpleasant. The present invention makes use of a portable alarm controller remote element for delaying the operation of an activated alarm signal of the alarm clock from a location that is apart from the base unit of the alarm clock. This allows for the placement of the alarm clock base unit in a location away from the sleeper, thereby incorporating the requirement to rise out of bed and touch the base unit as part of the alarm deactivating protocol for insuring an effective sleep-to-wakefulness transition. Another significant advantage provided by this aspect of the present invention is that the alarm clock ensures that oversleeping is prevented. None of the prior art devices achieve these results as successfully or in the manner proposed by the present invention.

The present invention has arisen to mitigate and/or obviate the afore-described disadvantages of conventional alarm clocks.

A need exists for a device or system that solves the above issues. The present invention fulfills those needs. It is an aspect of the invention to overcome or alleviate a problem of the prior art.

Accordingly, there is a need for an alarm clock with a remote and without a snooze feature to ensure the awakening of the sleeper. The invention proposes a remotely operated alarm clock with the disablement of the alarm only from a distance.

### BRIEF SUMMARY OF THE INVENTION

In view of the foregoing disadvantages inherent in the known types of alarm clock systems now present in the prior art, the present invention provides an improved alarm clock system with a remote control. The system of the present invention includes an alarm clock base unit with an audible alarm and a remote controller located at a distance from the base unit. As such, the general purpose of the present invention, which will be described subsequently in greater detail, is to provide an improved alarm clock system with a remote alarm controller and without a snooze option that has all of the advantages of the prior art and none of the disadvantages.

There has thus been outlined, rather broadly, the more important features of the invention in order that the detailed description thereof that follows may be better understood, and in order that the present contribution to the art may be better appreciated.

As such, those skilled in the art will appreciate that the conception upon which this disclosure is based may be readily utilized as a basis for the designing of other structures, methods, and systems for carrying out the several purposes of the present invention. It is important, therefore, that the claims be regarded as including such equivalent constructions insofar as they do not depart from the spirit and scope of the present invention.

It is a primary objective of the present invention to provide an improved alarm clock with a remote that may be easily and efficiently manufactured and marketed.

It is another objective of the present invention to provide an improved alarm clock with a remote control at a low cost of manufacture with regard to both materials and labor, and which, accordingly, is then susceptible of low prices of sale to the consuming public, thereby making such alarm clocks economically available to the buying public.

Another objective of the present invention is to provide an improved alarm clock system with a base unit and a remote alarm controller.

Another objective of the present invention is to provide an improved alarm clock system with a remote alarm controller that does not afford a sleeping person additional rest after the initial activation of an alarm.

Yet another objective of the present invention is to provide an alarm clock system with a remote alarm controller that disables the alarm only when placed at a distance.

Yet another objective of the present invention is to provide an alarm clock system with a remote alarm controller with the means for disabling the alarm provided only on the remote alarm controller thereby not allowing indefinite postponement of wakefulness.

Another objective of the present invention is to provide an alarm clock system with a remote alarm controller with a large, highly visible means for display on the base unit that allows placement at any convenient location rather than only in close proximity to the sleeper.

It is a further objective of the present invention to provide an alarm clock system that allows the current date and time to be displayed.

An even further objective of the present invention is to provide an alarm clock system that is capable of continued operation by using power from rechargeable batteries.

It is an objective of the present invention to provide an improved alarm clock system that includes a standard clock module that provides the basic timekeeping and alarm functions, thereby reducing the overall cost of the alarm clock system by reducing the number of discreet components required therein.

It is an even further objective of the present invention to provide an improved alarm clock system that may be easily and efficiently manufactured and marketed.

It is yet another objective of the present invention to provide an improved alarm clock system that is of durable and reliable construction.

Other aspects of the present invention will become apparent, from time to time, throughout the specification, as hereinafter related.

These, together with other objectives of the invention and the various features of novelty that characterize the alarm clock system of the present invention, are pointed out with particularity in the claims appended hereto and forming a part of this disclosure. The more important objectives of the present invention have been outlined rather broadly in order that the detailed description thereof which follows may be better understood, and in order that the present contribution to the art may be better appreciated. For a better understanding of the invention, its operational advantages, and the specific objectives attained by its uses, reference should be made to the accompanying drawings and descriptive matter, in which are illustrated various embodiments of the invention. Those skilled in the art will readily ascertain, however, that the invention is capable of other embodiments, and of being practiced and carried out in various ways. In this respect, the details of construction disclosed herein, and the arrangements of the components set forth in the following description and appended drawings, are for illustrative purposes only, and are not intended to be limiting in scope.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 shows a perspective view of the alarm clock base unit.

FIG. 2 shows a perspective view of the remote alarm controller.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

The present invention comprises an alarm clock system with an alarm clock base unit and means for receiving and transforming the alarm activation and deactivation or disabling signal. The alarm clock base unit has an exterior housing that houses means for setting the current time and date, means for displaying the current time and date, means for generating an audible alarm, means for setting at least a preferred alarm time, means for disabling the audible alarm and means of power source.

The alarm clock system of the present invention is further provided with a remote alarm controller, which is physically independent from the alarm clock base unit, and includes means for generating and transmitting the alarm activation and deactivation signal. The remote controller further includes means for setting and displaying the current time, as well as having self-contained power source means for energizing the various electronic components of the alarm remote controller. Therefore the remote alarm controller further comprises: means for activating the audible alarm from a distant location, means for disabling/deactivation the audible alarm and a power source.

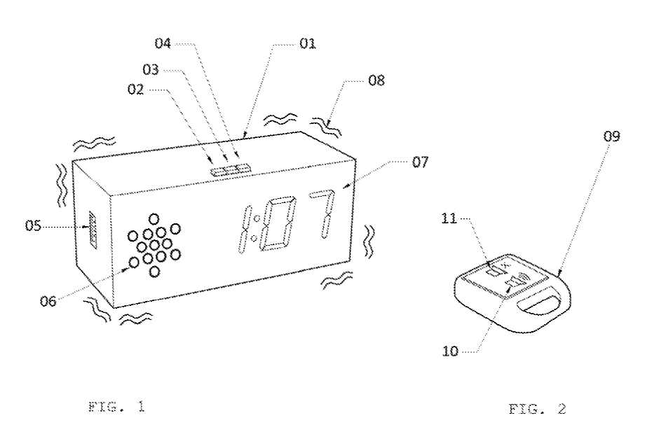

Referring now to the drawings, wherein like reference characters designate identical, or corresponding parts throughout the figures, and in particular FIGS. 1 & 2 show various embodiments of the alarm clock system in accordance with the present invention.

Fig.1 shows the front view of the alarm clock base unit, including an exterior housing 01, means for setting the current time 02, means for setting the current date 03, means for setting at least a preferred alarm time 04, means of power source 05, means for generating an audible alarm 06, means for displaying the current time and date 07, illustration of the vibration of the clock as an alarm 08.

Further FIG. 2 shows the top view of the remote alarm controller, including remote alarm controller 09, switch on remote 09 to turn on the alarm 10, switch on remote 09 to turn off the alarm 11.

In a preferred embodiment of the present invention the alarm clock system illustrated is divided into two main components: base unit and alarm controller remote. Illustrated in Fig.1 is the base unit further is having components including exterior housing 01, means for setting the current time 02, means for setting the current date 03, means for setting at least a preferred alarm time 04, with 02,03, and 04 being the control keys or preferably push button types switches. The means of power source 05 is for back-up power used for energizing the various electronic components of base unit. The means for generating an audible alarm 06 is at least one speaker and vibration alarm of the clock base unit 08 with advantage of using either audible alarm using speaker 06 or vibration 08 or both at the same time. Further as illustrated the means for displaying the current time and date 07 is selected from an LCD, LED, AMOLED, TFT and the like.

In another preferred embodiment of the present invention the remote alarm controller as illustrated in the FIG. 2 showing the top view of the remote alarm controller of the current alarm system, includes a remote alarm controller 09, provided with a switch to turn on the alarm 10 and a switch to turn off the alarm 11. The remote alarm controller 09 has the ability to activate the alarm ringer and disable the ringer enabling to start the base unit alarm clock ringer from the remote 09 such that the ringer can be activated from a distance and can not be disabled with the base unit of the clock system.

In another preferred embodiment of the invention the alarm clock system includes a clock with a base unit and an alarm controller remote provided with an alarm turn-off control device or means for disabling alarm in the form of a manual push button switch located only on the alarm controller remote. Further in a preferred embodiment of the invention the clock alarm system has means to generate two separate and distinct alarm sounds, consisting of a first sound in the form of a continuous tone sounding for an initial period, such as 30seconds, followed by a more strident shrill, pulsating sound for a second period, such as another 30 seconds. To turn off the alarm, the user must get out of bed, walk to location of the alarm controller remote 09, and then depress the alarm disabling means or the switch push button 11. The current alarm clock system can be used to require sufficient effort and concentration by the user when he attempts to deactivate the base unit alarm to ensure that the user reaches a wakeful state as a result of the deactivation procedure, thereby accomplishing the intended purpose of the alarm. The alarm deactivating arrangement forces the user to employ a special degree of attention when he attempts to deactivate the alarm, and requires mental concentration by the user to get out of bed and deactivate the alarm to produce substantially complete wakefulness. The improved system is relatively simple in construction, involving inexpensive and readily available components, and has a wide range of versatility in usage in that it can be arranged either with a remote control station or as a substantially self-contained composite assembly.

Those skilled in the art will be aware of a variety of means that are well known and used to select and adjust alarm system parameters, including key means, push-buttons, and rotatable dials or wheels, said means including appropriate conditioning circuitry for suitable interfacing to the other clock system electronics. As well, those skilled in the art will recognize various other designs, shapes, sizes, and configurations for forming the base unit and the alarm controller remote, which may perform in substantially the same manner as the embodiments of those elements described and illustrated herein, according to the present invention. It should be understood, therefore, that the overall aesthetic design and the choice of selection and adjustment means used in this embodiment of the present invention are not intended to be limiting. Also the words disable and deactivate are intended to grant same meaning in the current invention.

The material used for the front display panel on the base unit and the remote alarm controller is a translucent high-impact plastic material, such as that which is well known, for protecting the various optoelectronic display elements that are mounted behind the panel.

The alarm clock system with a remote control, as provided in the current system, does not afford a sleeping person additional rest after initial activation of an alarm. The alarm can be deactivated only from a distance, requiring the sleeper to get out of bed and use the remote to deactivate the alarm. The alarm clock system with the remote control does not allow indefinite postponement of wakefulness, thereby solving the purpose for which it is deployed. The large, highly visible display that allows placement at any convenient location rather than only in close proximity to the sleeper. The alarm clock also displays the current date. The clock is capable of continued operation by using power from the rechargeable batteries. The clock in the invention performs the standard clock module providing the basic timekeeping and alarm functions, thereby reducing the overall cost of the alarm clock system by reducing the number of discreet components required therein.

In an embodiment of the invention means for power source 05 is selected from a group of a replaceable battery,a rechargeable battery or a USB port. Further the USB port is used for energizing the gadgets from a group of cell phones, tablets, flash lights.

In an embodiment of the invention, the remote alarm controller 09 is used with the alarm clock and is capable of being used as a flash light for easy vision in the dark or at night.

The alarm clock system of the present invention may be set to a plurality of preferred alarm times. A preferred alarm time is both selected and enabled simultaneously using the alarm select/enable key, such that successive depression of the select/enable key enables the first preferred alarm time, the second alarm time, and may be used to disable the alarm.

While embodiments of the alarm clock system have been described in detail, it should be apparent that modifications and variations thereto are possible, all of which fall within the true spirit and scope of the invention. With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

The advantages of the present invention are: the alarm clock is convenient to activate and deactivate using a user friendly remote alarm controller. The deactivation signal is operational only when it is located at a far distance from the base, forcing the sleeper to awaken, thereby avoiding over sleeping.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. An alarm clock system comprising of an alarm clock base unit and means for receiving and transforming the alarm activation and deactivation signal wherein said alarm clock base unit comprises an exterior housing further comprising:
means for setting the current time and date,
means for displaying the current time and date,
means for generating an alarm,
means for setting at least a preferred alarm time,
means of power source.

2. An alarm clock system as claimed in claim 1, wherein said means for setting the current time on said base unit are manual push button switch.

3. An alarm clock system as claimed in claim 1, wherein said means for displaying the current time and date is selected from a group of an LCD, LED, TFT, AMOLED screen.

4. An alarm clock system as claimed in claim 1, wherein said means for alarm generating generates two alarms is separate and distinct alarm sounds.

5. An alarm clock system as claimed in claim 1, wherein said alarm is an audible alarm.

6. An alarm clock system as claimed in claim 1, wherein said alarm is in the form of a continuous tone sounding for an initial period, wherein said alarm is a more strident shrill, pulsating sound for a second period.

7. An alarm clock system as claimed in claim 1, wherein said means for generating an audible alarm is a speaker.

8. An alarm clock system as claimed in claim 1, wherein said means for generating alarm is vibration of said clock.

9. An alarm clock system as claimed in claim 1, wherein said means for generating alarm is both speaker and vibration of said clock.

10. An alarm clock system as claimed in claim 1, wherein said means for setting at least one preferred alarm time is at least one manual push button switch.

11. An alarm clock system as claimed in claim 1, wherein said means for power source is selected from a group of a replaceable battery,a rechargeable battery, a USB port.

12. An alarm clock system as claimed in claim 1, wherein said USB port is used for energizing the gadgets from a group of cell phones, tablets, flash lights.

13. An alarm clock system as claimed in claim 1, wherein said base unit is made of a translucent high-impact plastic material

14. An alarm clock system as claimed in claim 1, wherein said means for receiving and transforming the alarm activation and deactivation signal comprises a remote alarm controller.

15. An alarm clock system as claimed in claim 14, wherein said remote alarm controller is physically independent from the alarm clock base unit.

16. An alarm clock system as claimed in claim 14, wherein said remote alarm controller further comprises:
means for activating the audible alarm from a distant location;
means for disabling/deactivation the audible alarm;
a self-contained power source means wherein said means is used for energizing the various electronic components of said alarm remote controller.

17. An alarm clock system as claimed in claim 14, wherein said remote alarm controller is made of a translucent high-impact plastic material.

18. An alarm clock system as claimed in claim 14, wherein said means for disabling the audible alarm is at least one manual push button switch at said alarm controller remote.

19. An alarm clock system as claimed in claim 14, wherein said power source means includes a rechargable battery.

20. An alarm clock system as claimed in claim 14, wherein said means for disabling the audible alarm by depressing the switch push button when said base unit is at a distance from said remote alarm controller.
